(19) United States
(12) Patent Application Publication
(10) Pub. No.: US 2016/0189266 A1
(43) Pub. Date: Jun. 30, 2016

(54) TECHNOLOGIES FOR RULE-GUIDED AUTONOMOUS GOAL ACHIEVEMENT

(71) Applicants: Brian D. Johnson, Portland, OR (US); Anthony C. Salvador, Portland, OR (US)

(72) Inventors: Brian D. Johnson, Portland, OR (US); Anthony C. Salvador, Portland, OR (US)

(21) Appl. No.: 14/583,683

(22) Filed: Dec. 27, 2014

(51) Int. Cl. G06Q 30/06

(52) U.S. Cl. CPC G06Q 30/0617; G06Q 30/0605

(57) ABSTRACT

Technologies for autonomously determining conditions to achieve a goal include determining a goal to be achieved, determining a pool of available resources usable to achieve the goal, determining a set of rules to be satisfied to achieve the goal, updating the pool of available resources based on the determined set of rules, and determining the conditions required to achieve the goal utilizing resources from the updated pool of available resources that satisfies the set of rules. A set of final conditions may be determined to achieve a set of multiple goals. The goals, rules, and resources may be provided by a user, an agent of the resources, or otherwise determined or inferred by the disclosed system.

### BACKGROUND

Computing devices and computer-based services are becoming ubiquitous personal tools for the average consumer. Consumers are increasingly utilizing on-line shopping and virtual stores to obtain desired goods and services. As the on-line presence of companies, goods, services, and other resources grows the complexity of identifying a consumer's desired good or service increases. Oftentimes, the user must search for fixed resource offerings, and then determine whether such offerings meet the consumer's needs.

Some aggregation systems exist that aggregate offered resources to improve a consumer's ease of researching for a desired good or service. Such systems are typically focused on the offering of a single company or market space, limiting the choices of the consumer and the consumer's ability to direct the identification of the available resources. Additionally, such typical aggregation systems focus on the resources offered, rather than the particular overall goal to be achieved by the consumer.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for rule-guided autonomous goal achievement;

FIG. 2 is a simplified diagram of at least one embodiment of a goal achievement system of the system of FIG. 1;

FIGS. 3 and 4 are a simplified flow diagram of a method for determining conditions for achieving a set of goals based on a set of rules and available resources that may be executed by the goal achievement system of FIGS. 1 and 2; and

FIG. 5 is a simplified block diagram of a process flow for determining conditions for achieving a pair of goals based on a set of rules and available resources that may be implemented by the goal achievement system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A or C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

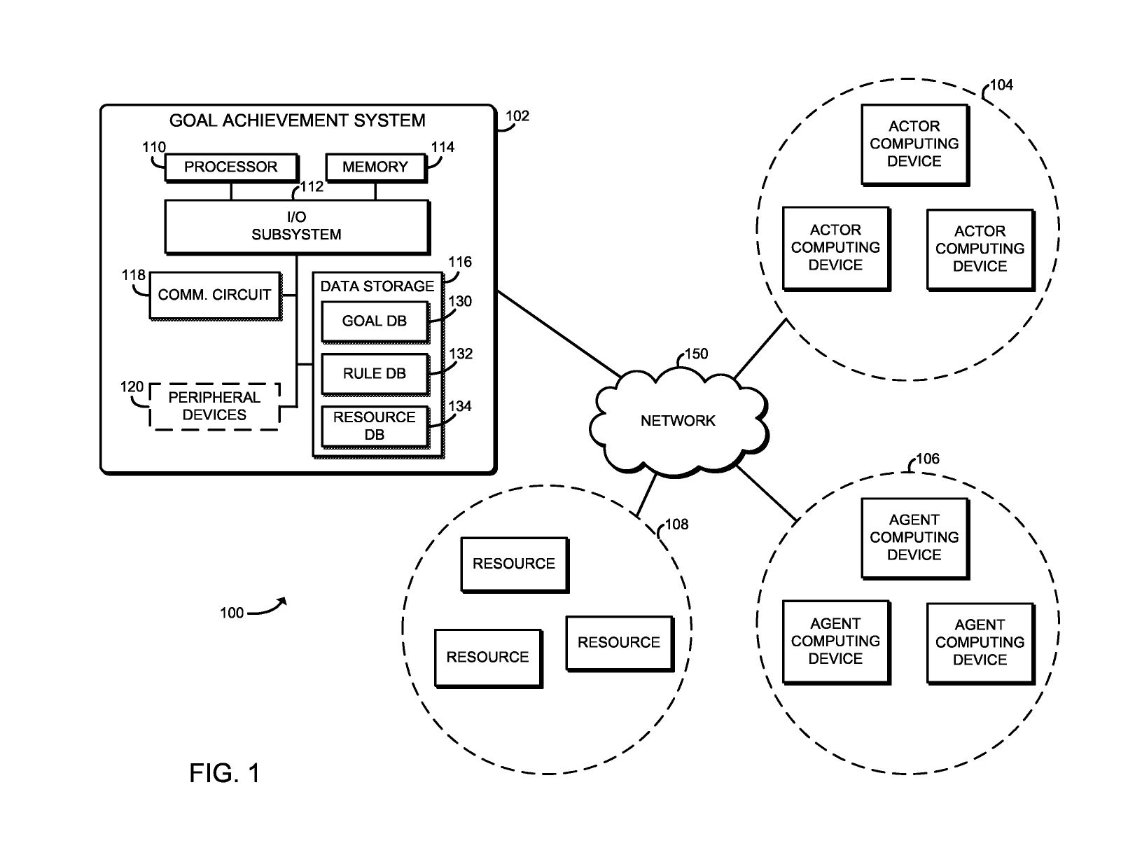

Referring now to FIG. 1, an illustrative system 100 for rule-guided autonomous goal achievement includes a goal achievement system 102, a pool of actor's and associated actor computing devices 104, a pool of agents and associated agent computing device 106, and a pool of resources 108, which may be controlled or available from one or more agents. Each of the actor computing devices 104 and agent computing devices 106 may communicate with the goal achievement system 102 over a network 150. In use, as discussed in more detail below, one or more actors or users may communicate with the goal achievement system 102 to request or submit a goal to be achieved. The requested goals may be common or similar from multiple actors or may be diverse. In the illustrative embodiment, the goals may be broadly defined. For example, one user's goal may be to “attend a soccer game in Rio de Janeiro,” “buy a Corvette,” or “attend New Year's party in New York.” Additionally, each actor or user may submit multiple goals, which may interrelated. For example, a user may request “attend a soccer game in Rio De Janeiro” and “visit Brazilian winery” or “complete goal cheaply.” The requested goals may be common or similar from multiple actors or may be diverse. For example, one actor or user may submit “attend a soccer game in Rio de Janeiro” and another actor may submit “visit Brazilian winery.” Further, in some embodiments, one or more agents may submit one or more goals to the goal achievement system 102. The goals submitted by agents generally relate to the resources controlled by the agents. For example, an agent goal may be to “sell plane ticket,” “sell hotel room,” or “sell tour service.”

Each actor or user, as well as each agent, may also submit one or more rules to be enforced or guide the competition of each goal. Each rule may be embodied as any type of restriction or limitation that must be considered in determining conditions to achieve any one or more goals. For example, an actor may submit a rule of “do not spend more than $1,000” or “complete goal in August,” in conjunction with a goal. Similarly, an agent may submit a goal of “do note sell ticket for less than $500,” “conduct flight in August,” or “participant must be over 21 years old.” Additionally, the goal achievement system 102 may infer or identify additional rules to be followed based on those submitted by the actors or agents, the goals to be achieved, or other criteria.

After the goal achievement system 102 has received one or more goals and associated rules from the actors (and agents), the goal achievement system 102 is configured to select one or more goals to be achieved. The selected goals may be from multiple users and/or agents and may be similar, dissimilar, or even contrary to each other. In some embodiments, the goal achievement system 102 may select the maximum number of goals to be achieved in one event or with one set of conditions. Regardless, after a set of goals has been determined, the goal achievement system 102 identifies a pool of resources 108 usable to achieve each of the selected goals. As discussed in more detail below, each resource may be embodied as any type of resource usable to achieve any goal. Of course, each resource may achieve only a sub-component of a single goal. For example, a goal of “attend a soccer game in Rio de Janeiro” may require a plane flight resource, a hotel resource, a taxi resource, a game ticket resource, and a dinner resource to achieve the single goal. In some embodiments, an agent may be embodied as a resource as well (e.g., a personal shuttle service or personal guide). It should be appreciated that the goal achievement system 102 may identify multiple, similar resources useable to achieve a single goal or component of a goal (e.g., selecting multiple airline flights or shuttle services). Additionally, as discussed in more detail below, the goal achievement system 102 may select the resources by contacting resource information services, which may be embodied as the agent computing devices 106, to identify which resources are available.

After the goal achievement system 102 has determined the pool of resources usable to achieve the one or more goals, the goal achievement system 102 updates the pool of resources based on the defined rules. For example, the goal achievement system 102 may remove resources and/or agents from the pool of resources such that the rules supplied by the actors and agents are satisfied. It should be appreciated that the goal achievement system 102 may reiterate this process many times to arrive at a final updated pool of resources usable to achieve the one or more goals while satisfying each rule associated with the goal and/or resource.

Once the goal achievement system 102 identifies the final pool of resources, the goal achievement system 102 determines a set of conditions to achieve the one or more goals using the identified final pool of resources while satisfying the associated rules. To do so, the goal achievement system 102 may execute multiple (e.g., millions or billions) of analysis iterations of resource and rule combinations to arrive at the final set of conditions. Additionally, the goal achieve system 102 may determine any number of sets of conditions. Each set of conditions identify the resources to be used as well as any criteria, limitation, or other condition used to achieve the goal. For example, a goal of “attend a soccer game in Rio de Janeiro” with an associated rule of “complete goal in August” may generate a set of conditions to achieve the goal that include “attend soccer game on August 25^{th},” “leave on August 17^{th},” “stay two nights in Miami, Fla.,” and “use 2-hour taxi service from hotel.” In arriving at the set of conditions, the goal achievement system 102 may utilize multiple actors, multiple agents, and multiple resources to achieve multiple goals. For example, one actor's goal may be to “attend a soccer game in Rio de Janeiro” and another actor's goal may be to “visit Brazilian winery.” By utilizing multiple goals from multiple actors, the goal achievement system 102 may be better able to achieve the identified goals (e.g., by arriving at a critical mass of actors required to utilize a given resource, such as a private airplane flight).

In this way, the goal achievement system 102 identifies the pool of resources used to achieve the goals for the actors, while also identifying the conditions required to utilize those resources to achieve the identified goals. It should be appreciated that the technologies disclosed herein are quite different from standard airline flight services or hotel reservation services in that multiple resources are identified to achieve a broad goal, as well as the set of conditions required to use the identified resources and achieve the selected goal. Further, the technologies disclosed herein facilitate the identification of resources and conditions useable to achieve goals from multiple actors, as well as agents of resources, some of which may be similar, dissimilar, or even diverse from each other.

The goal achievement system 102 may be embodied as any type of computing device or system capable determining conditions for achieving a goal and performing the functions described herein. For example, the goal achievement system 102 may be embodied as a server, a server controller, a distributed computing system, a multiprocessor system, a multi-computer system, a consumer electronic device, a laptop computer, a notebook computer, a tablet computer, a smartphone, and/or other computing device capable of determining conditions to achieve an identified goal. It should be appreciated that although the goal achievement system 102 is illustrated in FIG. 1 as a single computing device, the goal achievement system 102 may be embodied as a network or cloud of individual severs or other computing devices. For example, the goal achievement system 102 may be embodied as a cloud service in some embodiments.

As shown in FIG. 1, the goal achievement system 102 includes a processor 110, an I/O subsystem 112, memory 114, a data storage 116, a communication circuit 118, and one or more peripheral devices 120. Of course, the goal achievement system 102 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the goal achievement system 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the goal achievement system 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the goal achievement system 102, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. In some embodiments, the data storage 116 may store several databases for use during the determination of the set of conditions for achieving the identified goals. For example, as shown in FIG. 1, the data storage 116 includes a goal database 130, a rule database 132, and/or a resource database 134. The goal database 130 may store goals submitted or requested by the actors or agents, as well as additional global goals inferred or identified by the goal achievement system 102. Similarly, the rule database 132 may store the rules submitted by the actors and/or agents for achieving the goals, as well as additional global rules inferred or identified by the goal achievement system 102. The resource database 134 may store information related to the resources used to achieve the identified goals. Such information may be explicit (e.g., costs, availability, or other information) or general (e.g., access information identifying how to access the resources or information about the resources).

The communication circuit 118 may be embodied as any communication circuit, device, or collection thereof, capable of enabling communications between the goal achievement system 102 and the actor computing devices 104, the agent computing devices 106, and/or the resources 108. To do so, the communication circuit 118 may be configured to use any one or more communication technology and associated protocols (e.g., Ethernet, Bluetooth®, Wi-Fi®, WiMAX, etc.) to effect such communication.

The peripheral devices 120 may include any type of peripheral device commonly found in a typical computing device, such as various input/output devices. For example, the peripheral devices 120 may include display circuitry, various input buttons and switches, a keyboard, a mouse, speaker, microphone, and/or other peripheral devices.

Each of the actor computing device 104 and agent computing device 106 may be embodied as any type of computing device capable of communicating with the goal achievement system 102. For example, the computing devices 104, 106 may be embodied as computers, servers, desktop computers, smartphones, tablet computers, notebooks, laptops, a distributed computing system, a multiprocessor system, a multi-computer system, and/or other computing device. As such, the computing devices 104, 106 may include components commonly found in a computing device. For example, each of the computing devices 104, 106 may include one or more processors, memory, I/O subsystems, and communication circuits. Those components of the computing devices 104, 106 may be similar to the corresponding components of the goal achievement system 102, the description of which is equally applicable to the components of the computing devices 104, 106 and is not repeated herein for the clarity of description.

As discussed above, the resources 108 may be embodied as any type of resource usable to achieve a defined goal. The resources may include physical assets, such as airplanes, taxis, hotel rooms, tickets, vehicles, products, or the like, and/or services. In generally, each resource may be controlled by a corresponding agent, who may directly or indirectly identify the resource to the goal achievement system 102.

The network 150 may be embodied as any type of communication network capable of facilitating communication between the goal achievement system 102 and the actor computing devices 104, the agent computing devices 106, and/or the resources 108. As such, the network 150 may include one or more networks, routers, switches, computers, and/or other intervening devices. For example, the network 150 may be embodied as or otherwise include one or more local or wide area networks, cellular networks, publicly available global networks (e.g., the Internet), an ad hoc network, a short-range communication network or link, or any combination thereof.

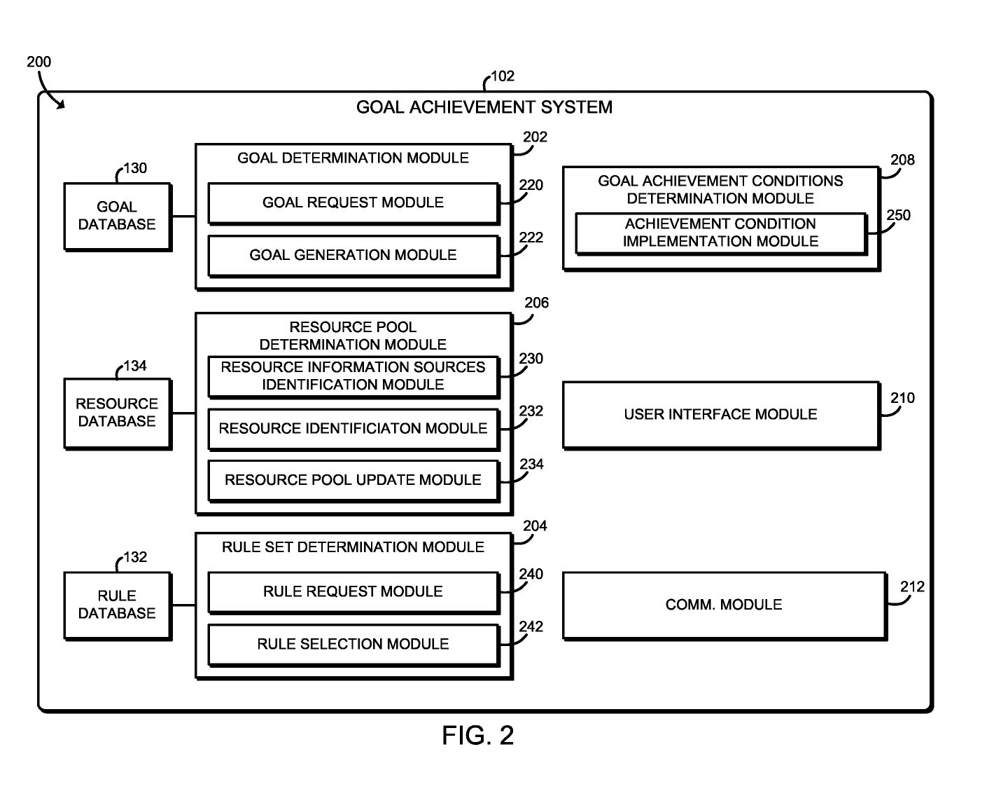

Referring now to FIG. 2, in use, the goal achievement system 102 may establish an environment 200. The illustrative environment 200 includes a goal determination module 202, a resource pool determination module 206, a rule set determination module 204, a goal achievement conditions determination module 208, a user interface module 210, and a communication module 212. Each of the modules and other components of the environment 200 may be embodied as firmware, software, hardware, or a combination thereof. For example the various modules, logic, and other components of the environment 200 may form a portion of, or otherwise be established by, the processor 110, the I/O subsystem 112, an SoC, or other hardware components of the goal achievement system 102. As such, in some embodiments, any one or more of the modules of the environment 200 may be embodied as a circuit or collection of electrical devices (e.g., a goal determination circuit, a resource pool determination circuit, a rule set determination circuit, a goal achievement circuit, etc.).

The goal determination module 202 identifies or selects one or more goals to be achieved from those goals submitted by the actors or agents (or otherwise inferred by the goal achievement system 102). To do so, the goal determination module 202 includes a goal request module 220 and a goal generation module 222. The goal request module 220 is configured to handle goal requests received from the actors or agents. For example, the goal request module 220 may provide an interface, via the user interface module 210, to facilitate the submission of a goal request to the goal achievement system 102. The goal request module 220 may store the submitted goals in the goal database 130. The goal generation module 222 is configured to select one or more goals to be achieved. As discussed above, multiple actors and/or agents may submit multiple goals. The goal generation module 222 is configured to select multiple goals from the multiple goals submitted by the actors and agents using any suitable selection algorithm. As discussed above, the goal generation module 222 may select similar or dissimilar goals in order to achieve each goal. For example, the goal generation module 222 may aggregate multiple goals to be achieved to facilitate the use of one or more resources to achieve each goal (e.g., aggregating goals to reduce the shared cost of a resource).

The resource pool determination module 206 is configured to identified resources usable to achieve the selected goals. To do so, the resource pool determination module 206 includes a resource information sources identification module 230, which is configured to identified resource information sources from which resources can be obtained. The resource information sources may be embodied as any type of source (e.g., online website, web service, booking service, travel itinerary, etc.) from which information (e.g., identity, availability, cost, etc.) can be obtained. In some embodiments, the resource information sources may be embodied as websites or services (e.g., company websites) maintained by agents of the resources. Additionally, in some embodiments, the agents may submit the resource information directly to the goal achievement system 102. The resource information obtained from the resource information sources may be stored in the resource database 134.

The resource pool determination module 206 also includes a resource identification module 232, which identifies available resources usable to achieve the selected goals. To do so, the resource identification module 232 may utilize the resource information obtained by the resource information sources identification module 230. For example, resource information sources identification module 230 may identify the website from which a train schedule may be obtained or analyzed, and the resource identification module 232 may utilize the identified website to determined or select a train ride from the train itinerary (as well as any cost, availability, restrictions, and/or other resource information) to achieve the selected goals.

As discussed above, the pool of identified resources is revised during the determination of the set of conditions to achieve the selected goals. As such, the resource pool determination module 206 also includes a resource pool update module 234 configured to update the pool of available resources. To do so, the resource pool update module 234 may update the pool of resources based on any suitable criteria including, but not limited to, the identified rules, the goals to be achieved, available agents, and/or remaining resources. In doing so, the resource pool update module 234 may utilize any suitable algorithm, such as a machine learning algorithm, to update the pool of resources based on the criteria.

The rule set determination module 204 is configured to determine the set of rules to be satisfied while achieving the selected goals. As discussed above, each rule may be embodied as any type of restriction or limitation that must be considered in determining conditions to achieve any one or more goals. For example, the rules may include a temporal rule that defines a temporal limitation to be satisfied to achieve the goal, a monetary rule that defines a monetary limitation to be satisfied to achieve the goal, an inclusion rule that defines an action, service, product, or other resource to be used to achieve the goal, or an exclusion rule that defines an action, service, product, or resource that cannot be performed to achieve the goal.

The rules may be submitted by the actor/user and or by an agent. As such, the rule set determination module 204 includes a rule request module 240 configured to handle rule submissions received from the actors or agents. For example, the rule request module 240 may provide an interface, via the user interface module 210, to facilitate the submission of a rule to the goal achievement system 102. The rule request module 240 may store the submitted rules in the rule database 132.

The rule set determination module 204 also includes a rule selection module 242 configured to select the rules to be used and satisfied in the selection of resources to achieve the identified goals. The rule selection module 242 may utilize any methodology to select the rules. For example, the rule selection module 242 may select those rules associated with the identified goals (e.g., the rules submitted by the actor along with the goal request) and/or those rules identified with each resource or agent. Additionally, in some embodiments, the rule selection module 242 may select rules from a global or standard rule set (e.g., a rule ensuring no local law is violate).

The goal achievement conditions determination module 208 is configured to determine multiple sets of conditions to achieve the identified goals. As discussed above, each set of conditions identify the resources to be used as well as any criteria, limitation, or other condition used to achieve the goal. The goal achievement conditions determination module 208 may perform any number of iterations, calculations, and analyses to arrive at the set of conditions. Additionally, the goal achievement conditions determination module 208 may determine any number of sets of conditions based on the goals, resources, and rules. To do so, the goal achievement conditions determination module 208 may utilize any suitable analysis algorithm including a machine learning algorithm to arrive at the set of conditions. In some embodiments, the goal achievement conditions determination module 208 may include an achievement condition implementation module 250. The achievement condition implementation module 250 is configured to implement the set of conditions to achieve the identified goals in response to acceptance of a set of conditions by the actors and agents. For example, the achievement condition implementation module 250 may automatically book airplane flights, reserve hotels, purchase tickets, reserve services, schedule events, or otherwise reserve, purchase, or obtain the various resources associated with the identified set of conditions.

As discussed above, the user interface module 210 is configured to provide an interface to actors and agents for interacting with the goal achievement system 102. For example, the user interface module 210 may be embodied as a web service or interface to facilitates submission of goals, rules, and/or resource information. Similarly, the communication module 212 facilitates communications between the goal achievement system 102 and the computing devices 104, 106 over the network 150 as discussed above.

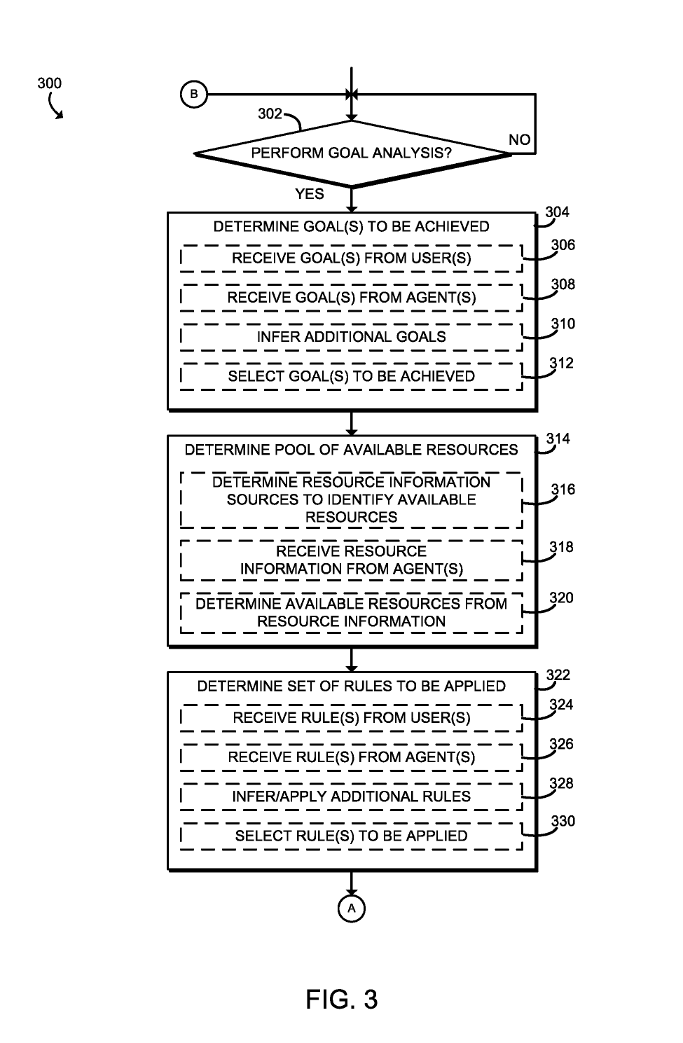

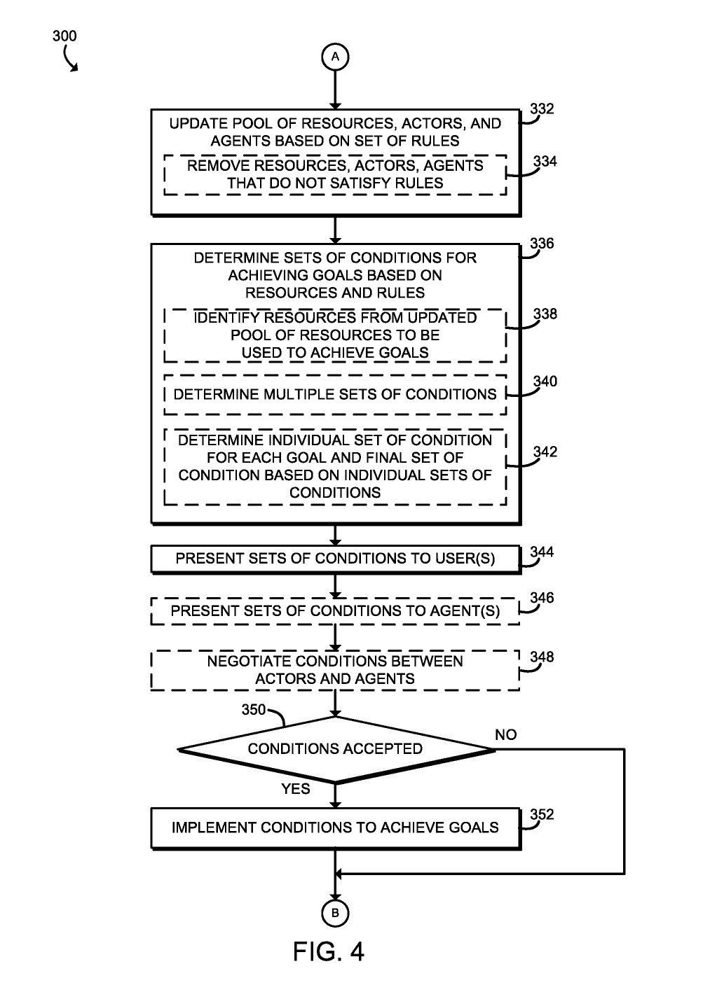

Referring now to FIGS. 3 and 4, during operation, the goal achievement system 102 may execute a method 300 for determining conditions for achieving a set of goals based on a set of rules and available resources. The method 300 begins with block 302 in which goal achievement system 102 determines whether to perform a goal achievement analysis. If so, the method 300 advances to block 304 in which the goal achievement system 102 determines or selects the goals to be achieve. To do so, in block 306, the goal achievement system 102 may receive one or more goals to be achieved from one or more users in block 306, receive one or more goals to be achieved from one or more agents in block 308, and may infer additional goals to be achieved based on the goals requested by the users and agents in block 310. In block 312, the goal achievement system 102 determines one or more goals to be achieved from the requested goals. As discussed above, the goal achievement system 102 may select one or more goals from the multiple goals submitted by the actors and agents using any suitable selection algorithm. Additionally, the goal achievement system 102 may aggregate multiple goals to be achieved to facilitate the use of one or more resources to achieve each goal (e.g., aggregating goals to reduce the shared cost of a resource).

After the goal achievement system 102 has selected the goals to be achieved, the method 300 advances to block 314 in which the goal achievement system 102 determines the pools of available resources. To do so, in block 316, the goal achievement system 102 may determine or identify the resource information sources useable to identify the available resources. As discussed above, each resource information source may be embodied as any type of source (e.g., online website, web service, booking service, travel itinerary, etc.) from which information (e.g., identity, availability, cost, etc.) can be obtained. The resource information sources may be identified from the resource database 134 and/or from information provided by the agents in block 318. Regardless, in block 320, the goal achievement system 102 determines the pool of available resources using the acquired resource information sources. For example, the goal achievement system 102 may access a website or web service identified as the resource information source to obtain information (availability, cost, restrictions, etc.) about available resources.

In block 322, the goal achievement system 102 determines or identifies the set of rules to be used and satisfied in the selection of resources to achieve the identified goals. To do so, the goal achievement system 102 may receive one or more rules to be applied from one or more users in block 324, receive one or more goals to be applied from one or more agents in block 326, and may infer or apply additional rules to be satisfied based on the goals or rules supplied by the users or agents in block 328. As discussed above, each rule may be embodied as any type of restriction or limitation that must be considered in determining conditions to achieve any one or more goals. In block 330, the goal achievement system 102 determines the set of rules to be satisfied in achieving the selected goals. To do so, in the illustrative embodiment, the goal achievement system 102 selects those associated with the identified goals (e.g., the rules submitted by the actor along with the goal request) and/or those rules identified with each resource or agent.

After the set of rules to be used in achieving the identified goals has been determined in block 322, the method 300 advances to block 332 as shown in FIG. 4. As discussed above, the goal achievement system 102 analyzes the goals, rules, and resources to determine a set of conditions to achieve the desired goals. In doing so, the goal achievement system 102 updates the pool of resources, the actors involved with the goals, and/or the agents used to achieve the goals based on the set of rules. For example, a particular set or collection of resources or agents may fail to satisfy the rules (e.g., too costly, unable to achieve a set date, etc.). As such, resources, actors, and/or agents may be removed from the calculation of the goal achievement in block 334. In this way, the determination of the set of conditions may be recursive or iterative and may include the reduction of identified resources, actors, and/or agents to arrive at the final set of conditions. For example, it should be appreciated that by removing a resource or agent from the determination of the set of conditions, a corresponding rule may be removed as well, which may allow the addition of other resources back into the determination.

In block 336, the goal achievement system 102 determines the sets of conditions for achieving the identified goals based on the updated pool of resources and the associated rules. For example, in block 338, the goal achievement system 102 identifies the particular resources from the updated pool of resources to be used to achieve the identified goals. Additionally, as discussed above, the goal achievement system 102 may determine multiple sets of conditions capable of achieving the identified goals based on the available resources and rules in block 340. When multiple goals are to be achieved, the goal achievement system 102 may determine separate, individual sets of conditions to achieve each goal (depending on the interconnectedness of the goals) and determine a final set of conditions based on the individual sets of conditions that achieves the combination of goals in block 342. For example, if the first goal is to “attend a soccer game in Rio De Janeiro” and the second goal is to “visit Brazilian winery,” the goal achievement system 102 may identify separate sets of conditions to achieve each goal and then identified a final set or sets of conditions to achieve both goals from the identified separate sets of conditions.

After the goal achievement system 102 has identified the sets of conditions to be used to achieve the selected goals in block 336, the method 300 advances to block 344 in which the goal achievement system 102 presents the sets of conditions to the actors/users for consideration. For example, the goal achievement system 102 may establish a web portal from which the actor/user can view or retrieve the sets of conditions and/or otherwise interact with the goal achievement system 102. Additionally, in some embodiments, the goal achievement system 102 may present the sets of conditions to the agents for consideration in block 346. In such embodiments, the goal achievement system 102 may further negotiate the identified conditions (or rules) between the actors and agents in block 348. For example, the goal achievement system 102 may request deductions in price, changes in schedules, special offers, or other modifications of the identified conditions to facilitate agreement between the actors and agents.

In block 350, the goal achievement system 102 determines whether the actors/users (and associated agents) has accepted one or more sets of conditions to achieve the identified goals. If so, the method 300 advances to block 352 in which the goal achievement system 102 implements the selected set of conditions. For example, the goal achievement system 102 may automatically book airplane flights, reserve hotels, purchase tickets, reserve services, schedule events, or otherwise reserve, purchase, or obtain the various resources associated with the identified set of conditions. After the set of conditions have been implemented or if no set of conditions have been accepted, the method 300 loops back to block 302 in which the goal achievement system 102 determines whether to perform another goal analysis. In this way, the goal achievement system 102 is able to determine a set of conditions required to achieve a goal desired by one or more users based on available resources while satisfying one or more rules supplied by the users and/or agents of the resources. It should be further appreciated that the determinations of the set of conditions may be performed with no interaction from the user after submission of the goals and associated rules. That is, the determination of the conditions to achieve the goals is performed by the goal achievement system 102 in an autonomous manner.

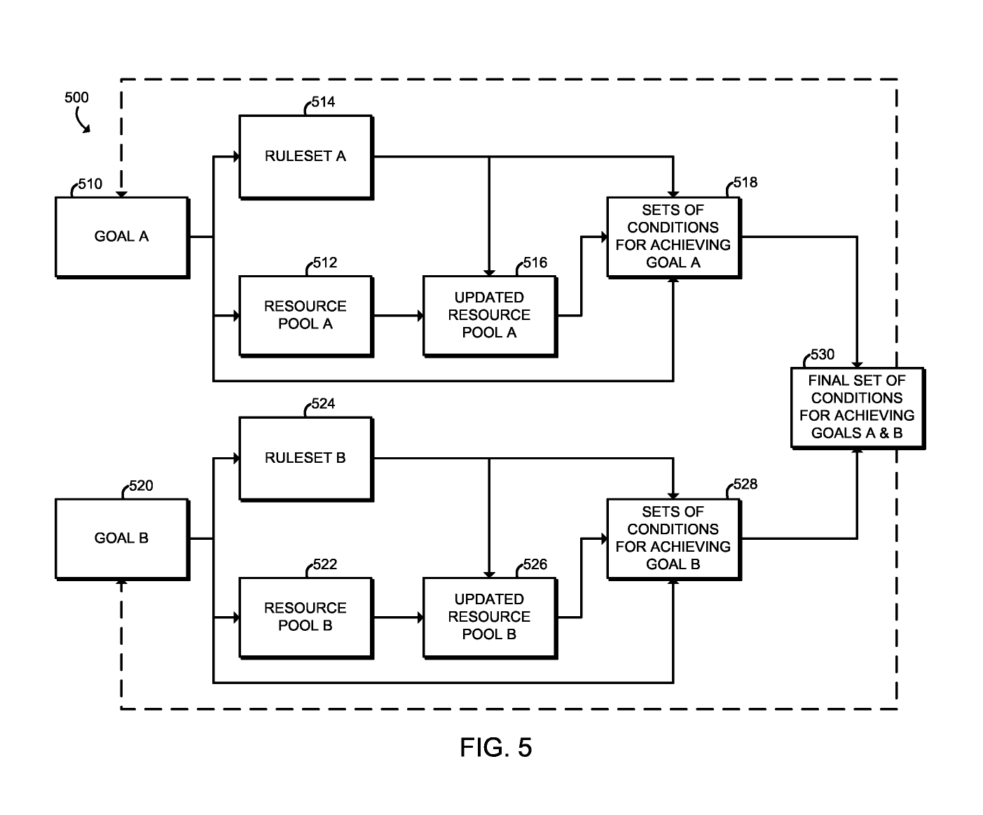

Referring now to FIG. 5, as discussed above, the goal achievement system 102 may determine conditions for achieving multiple goals in some embodiments. To do so, as explained above, the goal achievement system 102 may implement a process flow 500 in which a goal 510 and a goal 520 are initially identified. The goal achievement system 102 determines a pool of resources 512 for the goal 510 and a pool of resources 522 for the goal 520. Additionally, the goal achievement system 102 determines a set of rules 514 for the goal 510 and a set of rules 524 for the goal 520. Based on the corresponding resources 512, 522, the goal achievement system 102 determines separate updated resource pools 516, 526. Such determinations may be iterative or recursive as discussed above. Based on the updated resource pools 516, 526, the goal achievement system 102 determines corresponding sets of conditions 518, 528 for achieving the goals 510, 520. From the separate sets of conditions 518, 528, the goal achievement system 102 determines a final set or sets of conditions for achieving both goal 510 and goal 520.

### EXAMPLES

Illustrative examples of the devices, systems, and methods disclosed herein are provided below. An embodiment of the devices, systems, and methods may include any one or more, and any combination of, the examples described below.

Example 1 includes a goal achievement server for determining conditions to achieve a goal, the goal achievement server comprising a goal determination module to determine a goal to be achieved based at least in part on a goal request received from a user of the system; a resource pool determination module to determine a pool of available resources useable to achieve the goal, wherein the resource pool determination module is to determine resource information sources having resource information useable to identify an available resource and to communicate, over a network, with the resource information sources to identify at least one resource based on the resource information; a rule set determination module to determine a set of conditions the define requirements to be satisfied to achieve the goal, wherein the set of rules includes at least one rule defined by the user, wherein the resource pool determination module is to update the pool of available resources based on the set of rules to generate an updated pool of available resources; and a goal achievement conditions determination module to determine a set of conditions required to achieve the goal utilizing resources from the updated pool of available resources that satisfy the set of rules.

Example 2 includes the subject matter of Example 1, and wherein to determine the goal to be achieved comprises to determine the goal to be achieved based on multiple goal requests received from multiple users of the system.

Example 3 includes the subject matter of any of Examples 1 and 2, and wherein to determine the goal to be achieved comprises to determine the goal to be achieved based at least in part on a goal request received from an agent of a resource usable to achieve the goal.

Example 4 includes the subject matter of any of Examples 1-3, and wherein to determine the goal to be achieved comprises to infer the goal to be achieved based on the goal request from the user and the goal request from the agent.

Example 5 includes the subject matter of any of Examples 1-4, and wherein to determine the pool of available resources comprises to determine an agent of a resource usable to achieve the goal.

Example 6 includes the subject matter of any of Examples 1-5, and wherein to update the pool of available resources comprise to remove the agent from the pool of available resources based on the set of rules.

Example 7 includes the subject matter of any of Examples 1-6, and wherein to determine the pool of available resources comprises to determine at least one service or product useable to achieve the goal.

Example 8 includes the subject matter of any of Examples 1-7, and wherein to determine the pool of available resources comprises to receive resource information that defines a first available resource usable to achieve the goal from an agent of the first available resource.

Example 9 includes the subject matter of any of Examples 1-8, and wherein to determine the pool of available resources comprises to identify at least one remote server from which the resource information is obtainable, to communicate with the remote server over the network to retrieve the resource information, and to identify at least one available resource to achieve the goal based on the resource information.

Example 10 includes the subject matter of any of Examples 1-9, and wherein to determine the set of rules comprises to infer at least one rule based on another rule.

Example 11 includes the subject matter of any of Examples 1-10, and wherein the set of rules comprises a first rule defined by the user and a second rule defined by another user of the system.

Example 12 includes the subject matter of any of Examples 1-11, and wherein the set of rules includes at least one rule defined by an agent of a resource usable to achieve the goal.

Example 13 includes the subject matter of any of Examples 1-12, and wherein the set of rules includes at least one of (i) a temporal rule that defines a temporal limitation to be satisfied to achieve the goal, (ii) a monetary rule that defines a monetary limitation to be satisfied to achieve the goal, (iii) an inclusion rule that defines an action, service, or resource to be used to achieve the goal, or (iv) an exclusion rule that defines an action, service, or resource that cannot be performed to achieve the goal.

Example 14 includes the subject matter of any of Examples 1-13, and wherein to update the pool of available resources comprises to reduce the pool of available resources based on the set of rules.

Example 15 includes the subject matter of any of Examples 1-14, and wherein to reduce the pool of available resources comprises to remove those resources from the pool of available resources that do not satisfy at least one rule of the set of rules.

Example 16 includes the subject matter of any of Examples 1-15, and wherein the set of conditions identify a plurality of resources of the updated pool of available resources that are usable to achieve the goal and which satisfy the set of rules.

Example 17 includes the subject matter of any of Examples 1-16, and wherein each resource of the plurality of resources satisfies each rule of the set of rules.

Example 18 includes the subject matter of any of Examples 1-17, and wherein to determine a set of conditions comprises to determine a set of conditions that include actions to be performed by the user or an agent of a resource of the pool of available resources.

Example 19 includes the subject matter of any of Examples 1-18, and wherein to determine the goal to be achieved comprises to determine (i) a first goal to be achieved and (ii) a second goal to be achieved; to determine the pool of available resources comprises to determine (i) a first pool of available resources usable to achieve the first goal and (ii) a second pool of available resources usable to achieve the second goal; to determine the set of rules comprises to determine (i) a first set of rules to be satisfied to achieve the first goal and (ii) a second set of rules to be satisfied to achieve the second goal; to update the pool of available resources comprises to update (i) the first pool of available resources based on the first set of rules to generate an updated first pool of available resources and (ii) the second pool of available resources based on the second set of rules to generate an updated second pool of available resources; to determine the set of conditions comprises to determine (i) a first set of conditions to achieve the first goal utilizing the first updated pool of available resources and satisfying the first set of rules and (ii) a second set of conditions to achieve the second goal utilizing the second updated pool of available resources and satisfying the second set of rules; and wherein the goal achievement conditions determination module is further to determine a final set of conditions to achieve the first and second goal based on the first set of conditions and the second set of conditions.

Example 20 includes the subject matter of any of Examples 1-19, and wherein the second pool of available resources is determined based on the first pool of available resources.

Example 21 includes the subject matter of any of Examples 1-20, and wherein the first set of rules and the second set of rules include at least one common rule.

Example 22 includes the subject matter of any of Examples 1-21, and wherein the goal achievement conditions determination module is further to present the set of conditions to the user, receive a notification of agreement from the user, and implement the set of conditions based on the agreement from the user.

Example 23 includes the subject matter of any of Examples 1-22, and wherein to implement the set of conditions comprises to reserve the resources from the updated pool of available resources used to determine the set of conditions.

Example 24 includes a method for determining conditions to achieve a goal, the method comprising determining, by a goal achievement system, a goal to be achieved based at least in part on a goal request received from a user of the system; determining, by the goal achievement system, a pool of available resources useable to achieve the goal, wherein determining the available resources includes determining resource information sources having resource information useable to identify an available resource and communicating, over a network, with the resource information sources to identify at least one resource based on the resource information; determining, by the goal achievement system, a set of rules the define requirements to be satisfied to achieve the goal, wherein the set of rules includes at least one rule defined by the user; updating, by the goal achievement system, the pool of available resources based on the set of rules to generate an updated pool of available resources; and determining, by the goal achievement system, a set of conditions required to achieve the goal utilizing resources from the updated pool of available resources that satisfy the set of rules.

Example 25 includes the subject matter of Example 24, and wherein determining the goal to be achieved comprises determining the goal to be achieved based on multiple goal requests received from multiple users of the system.

Example 26 includes the subject matter of any of 24 and 25, and wherein determining the goal to be achieved comprises determining the goal to be achieved based at least in part on a goal request received from an agent of a resource usable to achieve the goal.

Example 27 includes the subject matter of any of Examples 24-26, and wherein determining the goal to be achieved comprises inferring the goal to be achieved based on the goal request from the user and the goal request from the agent.

Example 28 includes the subject matter of any of Examples 24-27, and wherein determining the pool of available resources comprises determining an agent of a resource usable to achieve the goal.

Example 29 includes the subject matter of any of Examples 24-28, and wherein updating the pool of available resources comprise removing the agent from the pool of available resources based on the set of rules.

Example 30 includes the subject matter of any of Examples 24-29, and wherein determining the pool of available resources comprises determining at least one service or product useable to achieve the goal.

Example 31 includes the subject matter of any of Examples 24-30, and wherein determining the pool of available resources comprises receiving resource information that defines a first available resource usable to achieve the goal from an agent of the first available resource.

Example 32 includes the subject matter of any of Examples 24-31, and wherein determining the pool of available resources comprises identifying at least one remote server from which the resource information is obtainable, communicating with the remote server over the network to retrieve the resource information, and identifying at least one available resource to achieve the goal based on the resource information.

Example 33 includes the subject matter of any of Examples 24-32, and wherein determining the set of rules comprises inferring, by the goal achievement system, at least one rule based on another rule.

Example 34 includes the subject matter of any of Examples 24-33, and wherein the set of rules comprises a first rule defined by the user and a second rule defined by another user of the system.

Example 35 includes the subject matter of any of Examples 24-34, and wherein the set of rules includes at least one rule defined by an agent of a resource usable to achieve the goal.

Example 36 includes the subject matter of any of Examples 24-35, and wherein the set of rules includes at least one of (i) a temporal rule that defines a temporal limitation to be satisfied to achieve the goal, (ii) a monetary rule that defines a monetary limitation to be satisfied to achieve the goal, (iii) an inclusion rule that defines an action, service, or resource to be used to achieve the goal, or (iv) an exclusion rule that defines an action, service, or resource that cannot be performed to achieve the goal.

Example 37 includes the subject matter of any of Examples 24-36, and wherein updating the pool of available resources comprises reducing the pool of available resources based on the set of rules.

Example 38 includes the subject matter of any of Examples 24-37, and wherein reducing the pool of available resources comprises removing those resources from the pool of available resources that do not satisfy at least one rule of the set of rules.

Example 39 includes the subject matter of any of Examples 24-38, and wherein the set of conditions identify a plurality of resources of the updated pool of available resources that are usable to achieve the goal and which satisfy the set of rules.

Example 40 includes the subject matter of any of Examples 24-39, and wherein each resource of the plurality of resources satisfies each rule of the set of rules.

Example 41 includes the subject matter of any of Examples 24-40, and wherein determining a set of conditions comprises determining a set of conditions that include actions to be performed by the user or an agent of a resource of the pool of available resources.

Example 42 includes the subject matter of any of Examples 24-41, and wherein determining the goal to be achieved comprises determining (i) a first goal to be achieved and (ii) a second goal to be achieved; determining the pool of available resources comprises determining (i) a first pool of available resources usable to achieve the first goal and (ii) a second pool of available resources usable to achieve the second goal; determining the set of rules comprises determining (i) a first set of rules to be satisfied to achieve the first goal and (ii) a second set of rules to be satisfied to achieve the second goal; updating the pool of available resources comprises (i) updating the first pool of available resources based on the first set of rules to generate an updated first pool of available resources and (ii) updating the second pool of available resources based on the second set of rules to generate an updated second pool of available resources; determining the set of conditions comprises determining (i) a first set of conditions to achieve the first goal utilizing the first updated pool of available resources and satisfying the first set of rules and (ii) a second set of conditions to achieve the second goal utilizing the second updated pool of available resources and satisfying the second set of rules; and further comprising determining a final set of conditions to achieve the first and second goal based on the first set of conditions and the second set of conditions.

Example 43 includes the subject matter of any of Examples 24-42, and wherein the second pool of available resources is determined based on the first pool of available resources.

Example 44 includes the subject matter of any of Examples 24-43, and wherein the first set of rules and the second set of rules include at least one common rule.

Example 45 includes the subject matter of any of Examples 24-44, and further including presenting the set of conditions to the user; receiving a notification of agreement from the user; and implementing the set of conditions based on the agreement from the user.

Example 46 includes the subject matter of any of Examples 24-45, and wherein implementing the set of conditions comprises reserving the resources from the updated pool of available resources used to determine the set of conditions.

Example 47 includes one or more computer-readable storage media comprising a plurality of instructions stored thereon that, in response to execution, cause a computing device to perform the method of any of claims 24-46.

Example 48 includes a mobile computing device for authenticating a user, the mobile computing device comprising means for performing the method of any of claims 24-46.

1. A goal achievement server for determining conditions to achieve a goal, the goal achievement server comprising:
a goal determination module to determine a goal to be achieved based at least in part on a goal request received from a user of the system;
a resource pool determination module to determine a pool of available resources useable to achieve the goal, wherein the resource pool determination module is to determine resource information sources having resource information useable to identify an available resource and to communicate, over a network, with the resource information sources to identify at least one resource based on the resource information;
a rule set determination module to determine a set of conditions the define requirements to be satisfied to achieve the goal, wherein the set of rules includes at least one rule defined by the user, wherein the resource pool determination module is to update the pool of available resources based on the set of rules to generate an updated pool of available resources; and
a goal achievement conditions determination module to determine a set of conditions required to achieve the goal utilizing resources from the updated pool of available resources that satisfy the set of rules.

2. The goal achievement server of claim 1, wherein to determine the goal to be achieved comprises to determine the goal to be achieved based on multiple goal requests received from multiple users of the system.

3. The goal achievement server of claim 1, wherein to determine the goal to be achieved comprises to determine the goal to be achieved based at least in part on a goal request received from an agent of a resource usable to achieve the goal.

4. The goal achievement server of claim 1, wherein to determine the pool of available resources comprises to determine an agent of a resource usable to achieve the goal.

5. The goal achievement server of claim 4, wherein to update the pool of available resources comprise to remove the agent from the pool of available resources based on the set of rules.

6. The goal achievement server of claim 1, wherein the set of rules comprises a first rule defined by the user and a second rule defined by another user of the system.

7. The goal achievement server of claim 1, wherein to determine a set of conditions comprises to determine a set of conditions that include actions to be performed by the user or an agent of a resource of the pool of available resources.

8. The goal achievement server of claim 1, wherein:
to determine the goal to be achieved comprises to determine (i) a first goal to be achieved and (ii) a second goal to be achieved;
to determine the pool of available resources comprises to determine (i) a first pool of available resources usable to achieve the first goal and (ii) a second pool of available resources usable to achieve the second goal;
to determine the set of rules comprises to determine (i) a first set of rules to be satisfied to achieve the first goal and (ii) a second set of rules to be satisfied to achieve the second goal;
to update the pool of available resources comprises to update (i) the first pool of available resources based on the first set of rules to generate an updated first pool of available resources and (ii) the second pool of available resources based on the second set of rules to generate an updated second pool of available resources;
to determine the set of conditions comprises to determine (i) a first set of conditions to achieve the first goal utilizing the first updated pool of available resources and satisfying the first set of rules and (ii) a second set of conditions to achieve the second goal utilizing the second updated pool of available resources and satisfying the second set of rules; and
wherein the goal achievement conditions determination module is further to determine a final set of conditions to achieve the first and second goal based on the first set of conditions and the second set of conditions.

9. The goal achievement server of claim 1, wherein the goal achievement conditions determination module is further to present the set of conditions to the user, receive a notification of agreement from the user, and implement the set of conditions based on the agreement from the user.

10. One or more computer-readable storage media comprising a plurality of instructions stored thereon that, in response to execution, cause a goal achievement server to:
determine a goal to be achieved based at least in part on a goal request received from a user of the system;
determine a pool of available resources useable to achieve the goal, wherein determining the available resources includes determining resource information sources having resource information useable to identify an available resource and communicating, over a network, with the resource information sources to identify at least one resource based on the resource information;
determine a set of rules the define requirements to be satisfied to achieve the goal, wherein the set of rules includes at least one rule defined by the user;
update the pool of available resources based on the set of rules to generate an updated pool of available resources; and
determine a set of conditions required to achieve the goal utilizing resources from the updated pool of available resources that satisfy the set of rules.

11. The one or more computer-readable storage media of claim 10, wherein to determine the goal to be achieved comprises to determine the goal to be achieved based on multiple goal requests received from multiple users of the system.

12. The one or more computer-readable storage media of claim 10, wherein to determine the goal to be achieved comprises to determine the goal to be achieved based at least in part on a goal request received from an agent of a resource usable to achieve the goal.

13. The one or more computer-readable storage media of claim 10, wherein to determine the pool of available resources comprises to determine an agent of a resource usable to achieve the goal.

14. The one or more computer-readable storage media of claim 13, wherein to update the pool of available resources comprise to remove the agent from the pool of available resources based on the set of rules.

15. The one or more computer-readable storage media of claim 10, wherein to determine a set of conditions comprises to determine a set of conditions that include actions to be performed by the user or an agent of a resource of the pool of available resources.

16. The one or more computer-readable storage media of claim 10, wherein to:
determine the goal to be achieved comprises to determine (i) a first goal to be achieved and (ii) a second goal to be achieved;
determine the pool of available resources comprises to determine (i) a first pool of available resources usable to achieve the first goal and (ii) a second pool of available resources usable to achieve the second goal;
determine the set of rules comprises to determine (i) a first set of rules to be satisfied to achieve the first goal and (ii) a second set of rules to be satisfied to achieve the second goal;
update the pool of available resources comprises to (i) update the first pool of available resources based on the first set of rules to generate an updated first pool of available resources and (ii) update the second pool of available resources based on the second set of rules to generate an updated second pool of available resources;
determine the set of conditions comprises to determine (i) a first set of conditions to achieve the first goal utilizing the first updated pool of available resources and satisfying the first set of rules and (ii) a second set of conditions to achieve the second goal utilizing the second updated pool of available resources and satisfying the second set of rules; and
wherein the plurality of instructions further cause the goal achievement server to determine a final set of conditions to achieve the first and second goal based on the first set of conditions and the second set of conditions.

17. The one or more computer-readable storage media of claim 10, wherein the plurality of instructions further cause the goal achievement server to:
present the set of conditions to the user;
receive a notification of agreement from the user; and
implement the set of conditions based on the agreement from the user.

18. A method for determining conditions to achieve a goal, the method comprising:
determining, by a goal achievement system, a goal to be achieved based at least in part on a goal request received from a user of the system;
determining, by the goal achievement system, a pool of available resources useable to achieve the goal, wherein determining the available resources includes determining resource information sources having resource information useable to identify an available resource and communicating, over a network, with the resource information sources to identify at least one resource based on the resource information;
determining, by the goal achievement system, a set of rules the define requirements to be satisfied to achieve the goal, wherein the set of rules includes at least one rule defined by the user;
updating, by the goal achievement system, the pool of available resources based on the set of rules to generate an updated pool of available resources; and
determining, by the goal achievement system, a set of conditions required to achieve the goal utilizing resources from the updated pool of available resources that satisfy the set of rules.

19. The method of claim 18, wherein determining the goal to be achieved comprises determining the goal to be achieved based on multiple goal requests received from multiple users of the system.

20. The method of claim 18, wherein determining the goal to be achieved comprises determining the goal to be achieved based at least in part on a goal request received from an agent of a resource usable to achieve the goal.

21. The method of claim 18, wherein determining the pool of available resources comprises determining an agent of a resource usable to achieve the goal.

22. The method of claim 21, wherein updating the pool of available resources comprise removing the agent from the pool of available resources based on the set of rules.

23. The method of claim 18, wherein determining a set of conditions comprises determining a set of conditions that include actions to be performed by the user or an agent of a resource of the pool of available resources.

24. The method of claim 18, wherein:
determining the goal to be achieved comprises determining (i) a first goal to be achieved and (ii) a second goal to be achieved;
determining the pool of available resources comprises determining (i) a first pool of available resources usable to achieve the first goal and (ii) a second pool of available resources usable to achieve the second goal;
determining the set of rules comprises determining (i) a first set of rules to be satisfied to achieve the first goal and (ii) a second set of rules to be satisfied to achieve the second goal;
updating the pool of available resources comprises (i) updating the first pool of available resources based on the first set of rules to generate an updated first pool of available resources and (ii) updating the second pool of available resources based on the second set of rules to generate an updated second pool of available resources;
determining the set of conditions comprises determining (i) a first set of conditions to achieve the first goal utilizing the first updated pool of available resources and satisfying the first set of rules and (ii) a second set of conditions to achieve the second goal utilizing the second updated pool of available resources and satisfying the second set of rules; and
further comprising determining a final set of conditions to achieve the first and second goal based on the first set of conditions and the second set of conditions.

25. The method of claim 18, further comprising:
presenting the set of conditions to the user;
receiving a notification of agreement from the user; and
implementing the set of conditions based on the agreement from the user.
